(19) United States
(12) Patent Application Publication
(10) Pub. No.: US 2010/0313595 A1
(43) Pub. Date: Dec. 16, 2010

(54) REFRIGERATOR

(76) Inventor: Sang-Wook Seo, Gyeongsangnam-Do (KR)

Correspondence Address: BIRCH STEWART KOLASCH & BIRCH, PO BOX 747, FALLS CHURCH, VA, 22040-0747, US

(21) Appl. No.: 12/867,959

(22) PCT Filed: Dec. 24, 2008
(86) PCT No.: PCT/KR08/07681

§ 371 Date: Aug. 17, 2010

(30) Foreign Application Priority Data
Feb. 18, 2008 (KR) 10-2008-0014591

(51) Int. Cl. F25C 5/18; F25D 23/02; B67D 7/08

(52) U.S. Cl. 62/344; 62/449; 222/52

(57) ABSTRACT

A refrigerator comprises: a body having a storage chamber and a door for selectively shielding the storage chamber; a dispenser disposed at one side on a front surface of the door, for dispensing ice pieces made in the body from outside of the body; and a dispensing guide unit disposed to the dispenser, and having a length controlled to be contracted or expanded in a dispensing direction of the ice pieces, for guiding the ice pieces in the dispensing direction. When water or ice pieces are dispensed from the refrigerator from outside, the dispensing guide unit has a controlled length to decrease a distance from a container to store the water or ice pieces. This may prevent the water or ice pieces from being scattered.

### TECHNICAL FIELD

The present invention relates to a refrigerator, and more particularly, to a refrigerator having a dispenser at an outer side of a body so that a user can dispense water or ice pieces without opening a door.

### BACKGROUND ART

Generally, a refrigerator serves to freshly store each kind of food items for a long time in a cooled state or a frozen state by supplying cool air to a storage chamber. The cool air is generated by a refrigeration cycle for circulating a refrigerant through compression, condensation, expansion, and evaporation processes. This refrigerator is considered as one of necessities.

A recent large refrigerator is provided with a discharging apparatus (hereinafter, will be referred to as dispenser) for dispensing water or ice pieces inside a storage chamber without opening a door. This dispenser allows a user to draw out water or ice pieces inside the storage chamber without opening the door, thereby preventing cool air inside the refrigerator from leaking out, and enhancing a user's convenience.

However, the conventional dispenser has the following problems.

Firstly, the dispenser is provided with a guide unit for guiding water or ice pieces dispensed from the refrigerator. This guide unit is spaced from a container such as a cup for putting ice pieces or water therein. This may cause the ice pieces or water to be scattered to outside of the container, which increases a user's dissatisfaction. Accordingly, has been proposed a method for preventing scattering of ice pieces or water dispensed from the refrigerator through the guide unit.

Secondly, the ice pieces are rapidly dispensed from the refrigerator due to the distance between an outlet of the guide unit and the container. This may cause a container having brittleness such as glass or ceramics may be easily broken. Accordingly, has been proposed a method for reducing a dispensing speed of the ice pieces.

### DISCLOSURE OF INVENTION

### Technical Problem

Therefore, it is an object of the present invention to provide a refrigerator capable of preventing scattering of water or ice pieces to outside of a container while the water or ice pieces are dispensed from the refrigerator through a dispenser, and capable of reducing a dispensing speed of the ice pieces.

### Technical Solution

To achieve these and other advantages and in accordance with the purpose of the present invention, as embodied and broadly described herein, there is provided a refrigerator, comprising: a body having a storage chamber and a door for selectively shielding the storage chamber; a dispenser disposed at one side on a front surface of the door, for dispensing ice pieces made in the body from outside of the body; and a dispensing guide unit disposed at the dispenser, and having a length controlled to be contracted or expanded in a dispensing direction of the ice pieces, for guiding the ice pieces in the dispensing direction.

The dispenser includes a housing concavely formed at a front surface of the door toward a rear surface; a transfer chute for communicating the housing with the storage chamber via the door; and a dispensing button disposed at one side of the housing, for allowing the ice pieces to be dispensed.

The transfer chute is disposed at an upper portion of the housing, and the dispensing guide unit is coupled to the housing so as to be communicated with the transfer chute.

The refrigerator further comprises an opening/closing member for selectively opening and closing one end of the transfer chute connected to the dispensing guide unit.

The dispensing guide unit includes a fixed guide portion fixed to one side of the dispenser, for receiving ice pieces through an opening disposed at one side thereof and guiding the ice pieces in a dispensing direction; a movable guide portion disposed in the fixed guide portion and movable in the dispensing direction of the ice pieces, for controlling a length of the dispensing guide unit; and a driving portion for moving the movable guide portion.

The fixed guide portion and the movable guide portion are formed in a cylindrical shape having opened upper and lower surfaces. When the movable guide portion is moved to the maximum extent in the dispensing direction of the ice pieces, the circumference of the upper surface of the movable guide portion comes in contact with an inner surface of the fixed guide portion.

One or more of the fixed guide portion and the movable guide portion is provided with an area decrease portion having a sectional surface decreased toward the dispensing direction of the ice pieces.

The movable guide portion is provided with a deceleration portion protruding from an inner surface thereof toward an inner side, so that the ice pieces passing therethrough can have a decreased moving speed by colliding with the deceleration portion.

The driving portion includes racks having one end fixed to the movable guide portion, and disposed in the dispensing direction of the ice pieces; and pinions disposed above the fixed guide portion, for moving the racks in the dispensing direction by being rotated.

The movable guide portion is provided with a distance sensor for sensing a distance from a lower surface of the movable guide portion to an object disposed in the dispensing direction of the ice pieces.

The refrigerator further comprises a controller for controlling the driving portion for motion of the movable guide portion, so that the distance sensed by the distance sensor when dispensing the ice pieces can be constant.

### ADVANTAGEOUS EFFECTS

The refrigerator according to the present invention has the following advantages.

When water or ice pieces are dispensed from the refrigerator from outside, the length of the dispensing guide unit is controlled to decrease a distance from a container to store the water or ice pieces. This may prevent the water or ice pieces from being scattered.

Also, since the dispensing guide unit has a controllable length, increased is a friction area with the water or ice pieces passing through the inside thereof. This may reduce a dispensing speed of the water or ice pieces.

Furthermore, the dispensing guide unit is provided therein with a deceleration portion so that the ice pieces dispensed from the refrigerator can collide with the deceleration portion when moving. This may more reduce a dispensing speed of the ice pieces.

Furthermore, the distance sensor and the controller are provided so that the length of the dispensing guide unit can be continuously changed according to the amount of the water or ice pieces contained in the container. This may more effectively prevent scattering of the water or ice pieces.

### BRIEF DESCRIPTION OF THE DRAWINGS

FIG. 1 is a view showing an inside and appearance of a refrigerator according to a first embodiment of the present invention,

FIG. 2 is a view showing a rear surface of a door installed with a dispenser in FIG. 1,

FIG. 3 is an exploded view of the dispenser of FIG. 1,

FIG. 4 is a sectional view taken along line I-I in FIG. 1,

FIG. 5 is an enlarged view of a dispensing guide unit of FIG. 4,

FIG. 6 is a perspective view of a movable guide portion and a driving portion of FIG. 5,

FIG. 7 is a sectional view taken along line II-II in FIG. 5, and

FIG. 8 is a sectional view of a dispensing guide unit of a refrigerator according to a second embodiment of the present invention.

### BEST MODE FOR CARRYING OUT THE INVENTION

Reference will now be made in detail to the preferred embodiments of the present invention, examples of which are illustrated in the accompanying drawings.

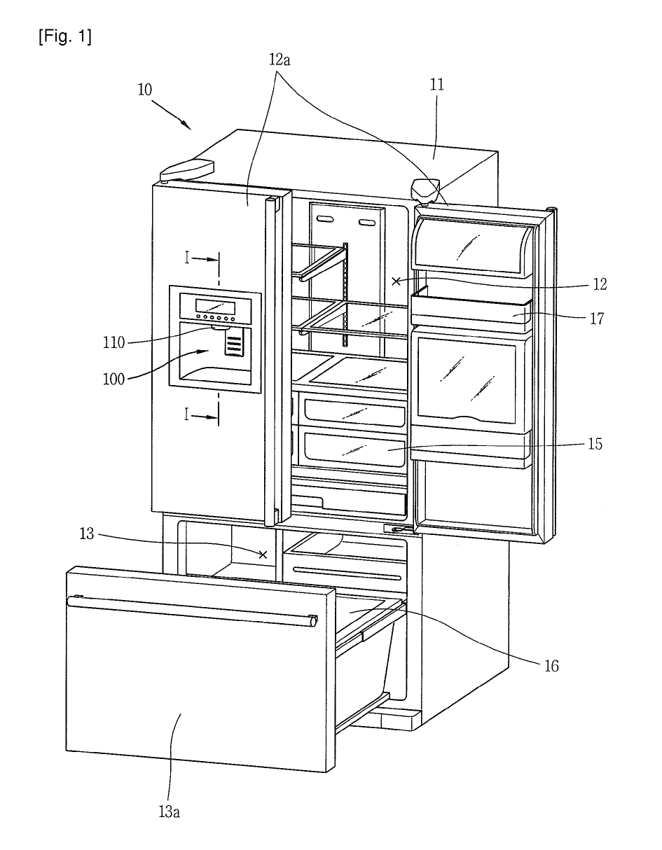

Hereinafter, a refrigerator according to a first embodiment of the present invention will be explained in more detail with reference to FIG. 1.

FIG. 1 is a view showing an inside and appearance of a refrigerator according to a first embodiment of the present invention.

Referring to FIG. 1, the refrigerator according to the first embodiment of the present invention comprises a body 10 having a storage chamber for storing items to be stored and a door for selectively shielding the storage chamber, and a refrigeration cycle (not shown) for generating cool air to be supplied to the storage chamber.

The storage chamber is composed of a refrigerating chamber 12 for freshly storing items such as food and beverage in a cooled state, and a freezing chamber 13 for storing items such as fish and meat in a frozen state.

The refrigerating chamber 12 and the freezing chamber 13 are disposed in the case 11 having an approximate rectangular parallelepiped shape that forms appearance of the body 10.

An insulating member is disposed between wall surfaces of the refrigerating chamber 12 and the freezing chamber 13 and a wall surface of the case 11, thereby preventing heat exchange between outside of the case 11 and inside of the refrigerating chamber 12 and the freezing chamber 13.

FIG. 1 illustrates the body 10 in which the refrigerating chamber 12 is disposed at an upper side, and the freezing chamber 13 is disposed at a lower side. However, it will be apparent to those skilled in the art that various modifications and variations of the refrigerator can be made in the present invention.

The refrigerating chamber 12 and the freezing chamber 13 are provided with opened surfaces through which items to be stored are put into or dispensed from the refrigerating chamber 12 and the freezing chamber 13. Refrigerating chamber doors 12a and a freezing chamber door 13a selectively shield the opened surfaces, respectively, which is shown in FIG. 1.

Referring to FIG. 1, the refrigerating chamber 12 is shielded by the two refrigerating chamber doors 12a hinge-coupled to both ends thereof. This is advantageous when a capacity of the refrigerating chamber 12 is to be increased in a horizontal direction.

More concretely, when the refrigerating chamber 12 is to be shielded by one door, the door has too large rotation radius. This may cause a user's inconvenience in opening and closing the door. However, owing to the two refrigerating chamber door 12a, the user's inconvenience is solved.

The freezing chamber door 13a is disposed so as to be drawn out toward a front side of the opened surface of the freezing chamber 13. Accordingly, when the freezing chamber 13 is disposed at a lower side, items stored in the freezing chamber 13 can be easily checked and dispensed.

Shelves 14, drawers 15, a basket 106, etc. for accommodating items to be stored may be provided in the refrigerating chamber 12 and the freezing chamber 13. A door basket 17 may be provided on a rear surface of the refrigerating chamber door 12a, i.e., on a surface toward the refrigerating chamber 12 when the refrigerating chamber door 12a is closed.

The refrigerator according to the present invention comprises a dispenser 100 for dispensing water or ice pieces from outside of the body 10, and a dispensing guide unit 110 for guiding the water or ice pieces dispensed from the refrigerator through the dispenser 100 into a container.

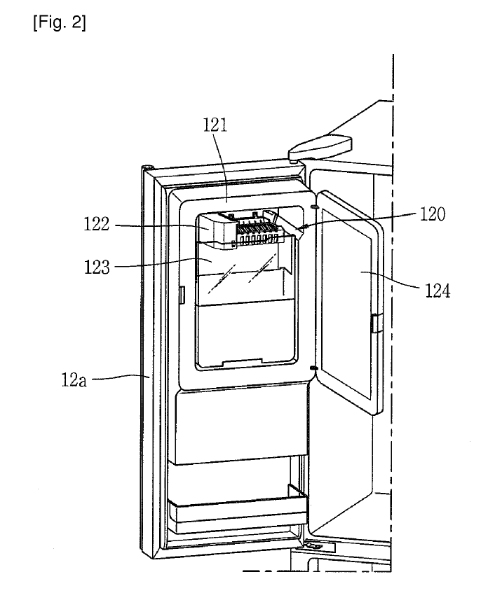

The refrigerator according to the present invention may further comprise an ice-making unit 120 (refer to FIG. 2) for making ice pieces to be dispensed from the refrigerator through the dispenser 100.

The ice-making unit will be explained in more detail with reference to FIG. 2.

FIG. 2 is a view showing a rear surface of a door installed with a dispenser in FIG. 1.

Referring to FIG. 2, the ice-making unit 120 is provided on a rear surface of the refrigerating chamber door 12a where the dispenser 100 is formed, i.e., a surface toward inside of the refrigerating chamber 12 when the refrigerating chamber door 12a is closed.

The ice-making unit 120 may be provided in the refrigerating chamber 12. In any cases, the ice pieces made by the ice-making unit 120 have to be supplied to the dispenser 100.

When the ice-making unit 120 is installed at the freezing chamber 13, an ice-making operation may be performed by cool air of the freezing chamber 13. However, when the ice-making unit 120 is installed at the refrigerating chamber 12 or the refrigerating chamber door 12a as shown in FIG. 2, an ice-making chamber 121 to supply cool air for ice-making is additionally provided. And, the ice-making chamber 121 is separately provided from the refrigerating chamber 12.

The ice-making unit 120 includes an icemaker 122 for making the ice pieces, an ice bank 123 for storing the ice pieces made by the icemaker 122 and transferring the ice pieces to the dispenser 100, and an ice-making chamber door 124 for partitioning the ice-making chamber 121 from the refrigerating chamber 12.

Structures of the icemaker 122 and the ice bank 123 have been already well known to those skilled in the art. Accordingly, detailed explanations of the icemaker 122 and the ice bank 123 will be omitted.

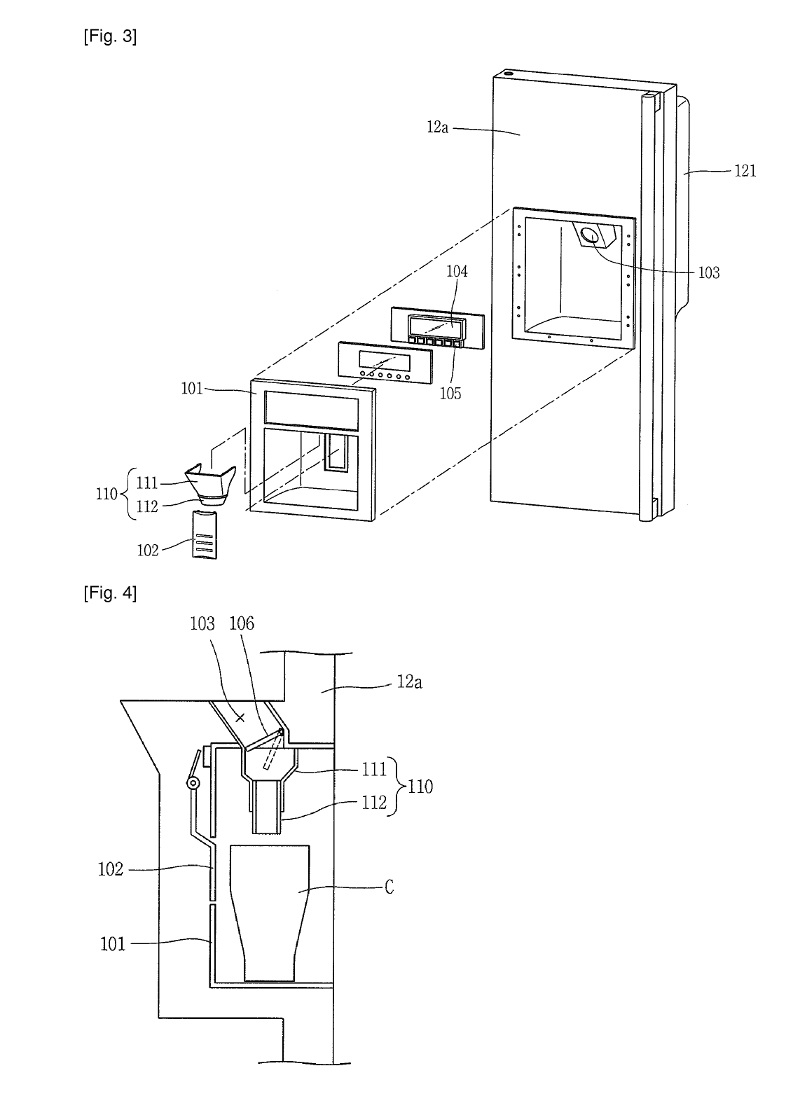

Hereinafter, the dispenser 100 will be explained in more detail with reference to FIG. 3.

FIG. 3 is an exploded view of the dispenser 100 of FIG. 1.

The dispenser 100 includes a housing 101 that forms a body of the dispenser 100, a communication chute 103 for communicating the housing 101 with the ice bank 123 by passing through the refrigerating chamber door 12a, and a dispensing button 102 for allowing the ice pieces to be dispensed.

An outlet side of the communication chute 103 is connected to the dispensing guide unit 110 for guiding a dispensing direction of ice pieces being dispensed from the refrigerator.

Here, the dispensing guide unit 110 is configured to have a length controlled to be contracted or expanded in a dispensing direction of the ice pieces, which will be later explained in more detail.

The housing 101 is concavely formed at a front surface of the refrigerating chamber door 12a, i.e., a surface towards outside of the body 10, toward a rear surface of the refrigerating chamber door 12a, so that a container (C) that stores water or ice pieces dispensed through the communication chute 103 can be accommodated therein.

The housing 101 may be integrally formed with a front surface of the refrigerating chamber door 12a, or may be additionally fabricated to be assembled with the refrigerating chamber door 12a.

Preferably, an outlet-side end of the communication chute 103 is formed at an upper middle portion of the housing 101. The end of an outlet side of the communication chute 103 is connected, via the communication chute 103, to an outlet of the ice bank 123 disposed on a rear surface of the refrigerating chamber door 12a.

Preferably, the dispensing button 102 is provided at an inner central portion of the housing 101 so as to be pressed with pushing the container (C) that stores water or ice pieces into the housing 101.

At an upper portion of the housing 101, provided is the dispensing guide unit 110 for guiding water or ice pieces dispensed from the refrigerator through the communication chute 103 in a dispensing direction.

Under this configuration, once the dispensing button 102 is pressed, ice pieces start to be transferred from the ice bank 123 through the communication chute 103. And, the transferred ice pieces are dispensed from the refrigerator through the dispensing guide unit 110.

At an upper portion of the housing 101, may be provided a plurality of buttons 105 for determining the kind of water or ice pieces dispensed from the refrigerator through the communication chute 103, or controlling the amount of the water or ice pieces, and a display 104 for displaying an operation state of the buttons 105.

Hereinafter, the dispensing guide unit 110 of the present invention will be explained in more detail with reference to FIGS. 4 to 6.

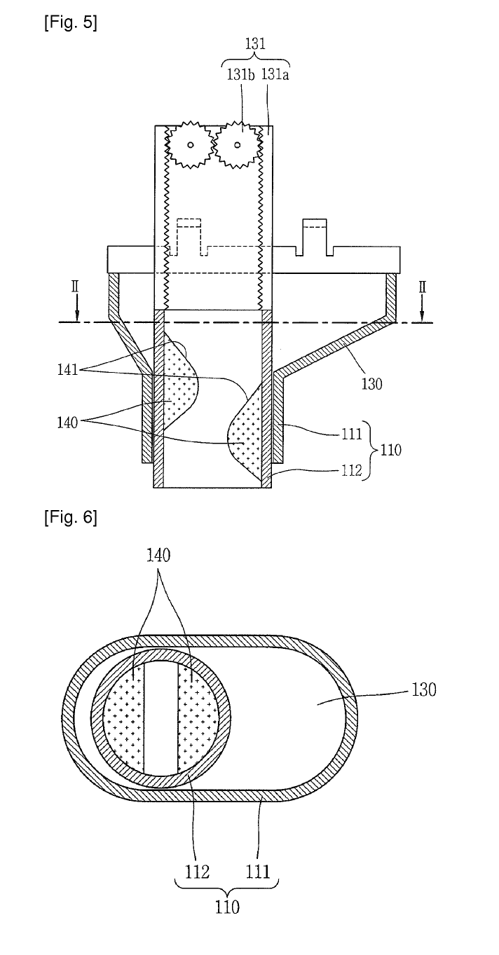

FIG. 4 is a sectional view taken along line I-I in FIG. 1, FIG. 5 is an enlarged view of the dispensing guide unit 110 of FIG. 4, and FIG. 6 is a perspective view of a movable guide portion and a driving portion of FIG. 5.

Referring to FIGS. 4 to 6, the dispensing guide unit 110 includes a fixed guide portion 111 fixed to the housing 101, a movable guide portion 112 disposed to be movable in the dispensing direction of the ice pieces, and a driving portion 120 for moving the movable guide portion 112.

The fixed guide portion 111 is formed in a cylindrical shape so as to guide ice pieces through inside thereof by being communicated with the communication chute 103, and is fixed to an upper portion of the housing 101.

The fixed guide portion 111 guides the ice pieces dispensed from the refrigerator through the communication chute 103 in the dispensing direction.

In order to prevent ice pieces from being abnormally dispensed from the refrigerator through the communication chute 103, an opening/closing member 106 for selectively opening and closing the communication chute 103 by being hinge-coupled to one side of the communication chute 103 is disposed at the end of an outlet-side of the communication chute 103.

The movable guide portion 112 is formed in a cylindrical shape having an outer diameter corresponding to an inner diameter of the fixed guide portion 111, so that it can move along an inner surface of the fixed guide portion 111.

In order to prevent ice pieces being dispensed from the refrigerator from being locked by an outer surface of the movable guide portion 112, the movable guide portion 112 is disposed so that an upper circumference thereof can come in contact with the inner surface of the fixed guide portion 111 when moving to the maximum extent in the dispensing direction of the ice pieces.

Here, the ice pieces dispensed from the refrigerator by being guided by the fixed guide portion 111 are again guided by the movable guide portion 1112, thereby being stably put into the container (C) that contains the ice pieces. This may prevent the ice pieces being dispensed from the refrigerator from scattering out of the container (C).

The movable guide portion 112 is coupled to the driving portion 120 so as to be movable.

The driving portion 120 may be composed of a rope, and a motor for controlling the position of the movable guide portion 112 by winding or unwinding the rope. Preferably, as shown in FIGS. 5 and 6, the driving portion 120 is configured as a gear composed of racks 131a and pinions 131b.

Under this configuration, the position of the movable guide portion 112 being moved can be precisely controlled. And, swing and noise occurring when the movable guide portion 112 moves can be prevented.

Hereinafter, a coupling process between the driving portion 120 and the movable guide portion 112 will be explained.

The rack 121 has one end fixed to an upper circumference of the movable guide portion 112, and is installed at an upper side in a length direction of the movable guide portion 112.

The rack 121 may be installed in one in number to move the movable guide portion 112. However, the rack 121 is preferably installed in two in number so smoothly move the movable guide portion 112. In this case, the two racks 121 are disposed to face each other.

The drawings show the latter case, which will be explained in more detail.

The pinions 131b are coupled to the racks 131a facing each other, respectively. And, the pinions 131b are provided in an even number so that the racks 131a can be movable in the same direction.

The even number of pinions 131b are disposed to have the same rotation angular velocity so that the racks 131a facing each other can have the same moving distance.

Under this configuration, once one of the even number of pinions 131b is rotated by a motor 131c connected to the driving portion 120, another pinion 131b coupled to the driving portion 120 is rotated. Accordingly, the racks 131a connected to the pinions 131b are linearly moved in upper and lower directions, thereby moving the movable guide portion.

Preferably, the dispensing guide unit 110 is provided with an area decrease portion 130, so that ice pieces dispensed from the refrigerator can be accommodated in the container (C) that contains the ice pieces.

The area decrease portion 130 is formed at the fixed guide portion 111, and has a sectional surface decreased toward the dispensing direction of the ice pieces.

This may prevent scattering of the ice pieces to outside of the container (C).

In the present invention, the dispensing guide unit 110 is preferably provided with a deceleration portion 140 for reducing a dispensing speed of the ice pieces dispensed from the refrigerator.

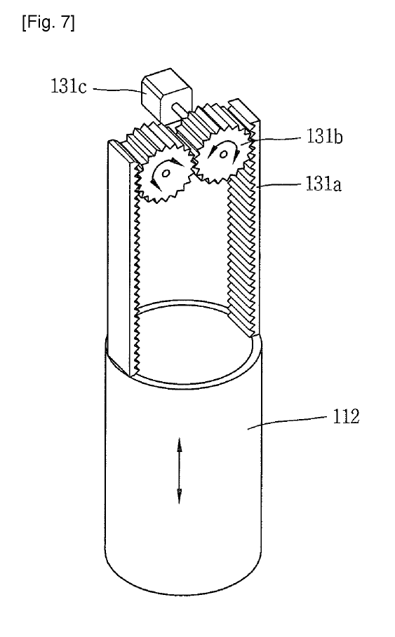

The deceleration portion will be explained in more detail with reference to FIG. 7.

FIG. 7 is a sectional view taken along line II-II in FIG. 5.

Referring to FIGS. 5 and 7, the deceleration portion 140 is protruding from an inner surface of the movable guide portion 112 toward an inner side of the movable guide portion 112.

Accordingly, the ice pieces passing through inside of the deceleration portion 140 have a decreased moving speed by colliding with the deceleration portion 140.

Preferably, the area decrease portion 130 is alternately disposed in two or more in number on facing inner surfaces of the movable guide portion 112 with a predetermined gap therebetween in the dispensing direction of the ice pieces.

The two deceleration portions 140 are formed so that an area formed therebetween can be large enough for one ice piece to easily pass therethrough, but too small to pass two ice pieces therethrough.

One deceleration portion 140 formed on an inner surface of the movable guide portion 112 is preferably provided with an inclined portion 141, so that ice pieces having collided with the inclined portion 141 can be guided to another deceleration portion 140 facing the deceleration portion 140 formed on the inner surface of the movable guide portion 112.

Another deceleration portion 140 formed at the lowest side of the movable guide portion 112 in the dispensing direction of the ice pieces is preferably provided with an inclined portion 141 in the dispensing direction of the ice pieces.

Under this configuration, ice pieces having been introduced into the movable guide portion 112 collide with the deceleration portion 140, thus to have a decreased dispensing speed. This may prevent the ice pieces being dispensed from the refrigerator from colliding with the container that stores the ice pieces, thereby preventing the container from being broken. This may also prevent scattering of liquid contained in the container that may occur when the ice pieces are dispensed from the refrigerator.

Hereinafter, a refrigerator according to a second embodiment of the present invention will be explained in more detail. Explanations for the same constructions as those of the first embodiment will be omitted.

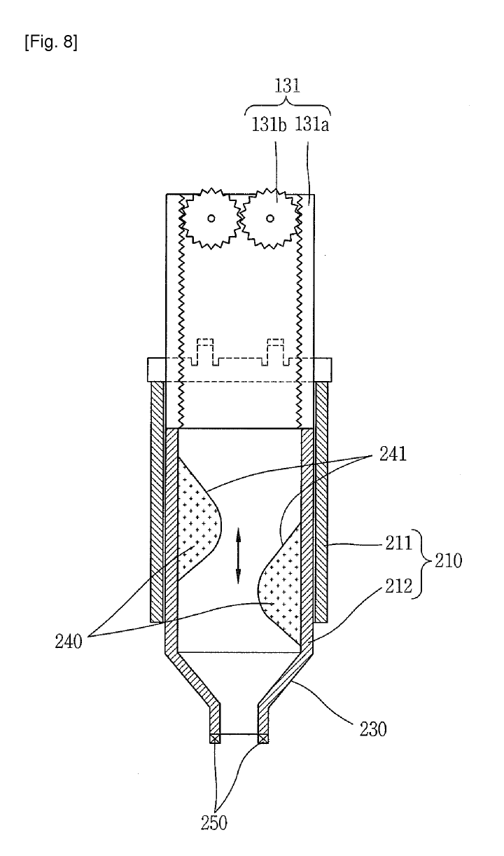

FIG. 8 is a sectional view of a dispensing guide unit of a refrigerator according to a second embodiment of the present invention.

Referring to FIG. 8, a fixed guide portion 211 and a movable guide portion 212 are formed in a cylindrical shape having opened upper and lower surfaces. The movable guide portion 212 and the fixed guide portion 211 are coupled to each other so that an upper circumference of the movable guide portion 212 can come in contact with an inner surface of the fixed guide portion 211. And, the movable guide portion 212 is disposed so as to be movable by a driving portion 220 in the dispensing direction of the ice pieces.

The contacted state between the upper circumference of the movable guide portion 212 and the inner surface of the fixed guide portion 211 is continuously maintained while the movable guide portion 212 is moved in the dispensing direction of the ice pieces.

To this end, an area decrease portion 230 formed at the fixed guide portion 211 is preferably formed below the movable guide portion 212.

On a lower surface of the movable guide portion 212, provided are distance sensors 250 for sensing a distance between the lower surface of the movable guide portion 212 and an object disposed below the movable guide portion 212.

Here, the object disposed below the movable guide portion 212 may correspond to water or ice pieces stored in a container after being dispensed from the refrigerator through a dispensing guide unit 210.

Therefore, a distance between the lower surface of the movable guide portion 212 and a maximum height surface of the water or ice pieces stored in the container can be uniformly maintained.

This may be achieved by a controller (not shown) for controlling the driving portion 220 based on distance information obtained by the distance sensor 250.

It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A refrigerator, comprising:
a body having a storage chamber and a door for selectively shielding the storage chamber;
a dispenser disposed at one side on a front surface of the door, for dispensing ice pieces made in the body from outside of the body; and
a dispensing guide unit disposed to the dispenser, and having a length controlled to be contracted or expanded in a dispensing direction of the ice pieces, for guiding the ice pieces in the dispensing direction.

2. The refrigerator of claim 1, wherein the dispenser comprises:
a housing concavely formed at a front surface of the door toward a rear surface of the door;
a transfer chute for communicating the housing with the storage chamber via the door; and
a dispensing button disposed at one side of the housing, for allowing the ice pieces to be dispensed.

3. The refrigerator of claim 2, wherein the transfer chute is disposed at an upper portion of the housing, and
wherein the dispensing guide unit is coupled to the housing so as to be communicated with the transfer chute.

4. The refrigerator of claim 2, further comprising an opening/closing member for selectively opening and closing one end of the transfer chute connected to the dispensing guide unit.

5. The refrigerator of claim 1, wherein the dispensing guide unit comprises:
a fixed guide portion fixed to one side of the dispenser, for receiving ice pieces through an opening disposed at one side thereof and guiding the ice pieces in a dispensing direction;
a movable guide portion disposed in the fixed guide portion and movable in the dispensing direction of the ice pieces, for controlling a length of the dispensing guide unit; and
a driving portion for moving the movable guide portion.

6. The refrigerator of claim 5, further comprising a controller for moving the movable guide portion, such that a distance between a lower end of the movable guide portion and an uppermost surface of the ice pieces stored in the container is uniformly maintained.

7. The refrigerator of claim 5, wherein the fixed guide portion and the movable guide portion are formed in a cylindrical shape having opened upper and lower surfaces, and
wherein when the movable guide portion is moved to the maximum extent in the dispensing direction of the ice pieces, an upper circumference of the movable guide portion is adhered to an inner surface of the fixed guide portion.

8. The refrigerator of claim 5, wherein one or more of the fixed guide portion and the movable guide portion is provided with an area decrease portion having a sectional surface decreased toward the dispensing direction of the ice pieces.

9. The refrigerator of claim 5, wherein the movable guide portion is provided with a deceleration portion protruding from an inner surface thereof toward an inner side, such that the ice pieces passing therethrough has a decreased moving speed by colliding with the deceleration portion.

10. The refrigerator of claim 9, wherein the area decrease portion is alternately disposed in two or more in number on facing inner surfaces of the movable guide portion with a predetermined gap therebetween in the dispensing direction of the ice pieces.

11. The refrigerator of claim 10, wherein the deceleration portion of the movable guide portion is provided with an inclined portion, such that ice pieces having collided with the inclined portion are guided to another deceleration portion facing the deceleration portion of the movable guide portion.

12. The refrigerator of claim 5, wherein the driving portion comprises:
racks having one end fixed to the movable guide portion, and disposed in the dispensing direction of the ice pieces; and
pinions disposed above the fixed guide portion, for moving the racks in the dispensing direction by being rotated.

13. The refrigerator of claim 5, wherein the fixed guide portion and the movable guide portion are formed in a cylindrical shape having opened upper and lower surfaces, and
wherein when the movable guide portion is moved to the maximum extent in the dispensing direction of the ice pieces, an upper circumference of the movable guide portion comes in contact with an inner surface of the fixed guide portion.

14. The refrigerator of claim 13, wherein the movable guide portion is provided with a distance sensor for sensing a distance from a lower surface of the movable guide portion to an object disposed in the dispensing direction of the ice pieces, and
wherein the refrigerator further comprises a controller for controlling the driving portion for motion of the movable guide portion, such that the distance sensed by the distance sensor when dispensing the ice pieces is constant.
